(19) United States
(12) Patent Application Publication
(10) Pub. No.: US 2021/0172597 A1
(43) Pub. Date: Jun. 10, 2021

(54) DURABLE EVEN HEAT BURNER FOR CONVEYOR CHARBROILER

(71) Applicant: UTILIZATION TECHNOLOGY DEVELOPMENT, NFP, DES PLAINES, IL (US)

(72) Inventors: Frank JOHNSON, Elmhurst, IL (US); Shawn SCOTT, Mount Prospect, IL (US)

(73) Assignee: UTILIZATION TECHNOLOGY DEVELOPMENT, NFP, DES PLAINES, IL (US)

(21) Appl. No.: 17/113,889

(22) Filed: Dec. 7, 2020

Related U.S. Application Data
(60) Provisional application No. 62/944,741, filed on Dec. 6, 2019.

(51) Int. Cl. F23D 14/14; F23D 14/70; F23D 14/82

(52) U.S. Cl. CPC F23D 14/145; F23D 14/70; A47J 37/044; F23D 2203/103; F23D 14/82

(57) ABSTRACT

A burner assembly including a burner box with an inlet for the introduction of a combustible mixture and a block plate integrated with the burner box. The block plate assists in a desired distribution of the combustible mixture. A distribution plate overlying the block plate and a single mesh surface above the distribution plate contribute to overall improved pressure and distribution of heat across the burner assembly.

### CROSS REFERENCE TO RELATED APPLICATION

This application claims the benefit of U.S. provisional application, Ser. No. 62/944,741, filed on 6 Dec. 2019. The co-pending provisional application is hereby incorporated by reference herein in its entirety and is made a part hereof, including but not limited to those portions which specifically appear hereinafter.

### BACKGROUND OF THE INVENTION

### Field of the Invention

This invention generally relates to cooking appliances and assemblies and, more particularly, to conveyor cooking appliances and assemblies such as charbroilers.

### Discussion of Related Art

Conveyor charbroilers are common commercial foodservice appliances used to quickly cook food item protein such as burgers or chicken, for example, in quick serve restaurants (“QSRs”). In common practice, a raw or frozen food item is placed on a conveyor that moves the food item through a heated chamber for cooking. The most common burner design uses a box-like burner with 5-7 layers of a screen material on the surface of the burner to distribute a flame, provide pressure drop and hold the flame.

FIG. 1 shows a side view of a standard burner assembly, generally designated by the reference numeral 110. The burner assembly 110 includes a box burner 112 with an inlet 114 for the introduction of a fuel gas (e.g., natural gas) and oxidant (e.g., air) combustible mixture. The box burner includes a block plate 116 to assist in desired distribution of the combustible mixture. The burner 110 further includes five layers 131, 132, 133, 134, and 135 of a screen material on the surface of the burner to distribute the flame, provide pressure drop and hold the flame. In such a design, the total of the five screen layers can together form a thickness of one-quarter inch or more.

A problem with these types of burners is attaining and maintaining an even distribution of fuel and air mixture inside five burner used to generate or produce the flame so that an even flame is formed at or on the burner surface. Current conveyor charbroilers use multiple screen burners which buckle, thereby forming gaps between the screen layers, resulting in uneven hearing and eventual failure of the burner assembly. Any unevenness in heating can result in uneven thermal expansion in the layers of the screen material to create or result in gaps between the layers. Such gaps commonly can create even greater unevenness in pressure distribution on the surface of the burner to cause or result in buckling and/or generation of severe hot spots. FIG. 2 shows a side view of the burner shown in FIG. 1 with gaps formed. This burner 110′ now has hot spots on the 5-layer screen burner surface leading to screen warping from uneven pressure and flame distribution. This leads to excessive stress on the burner screens and eventual failure. In the event of such failure, the general practice is to cut, remove and/or discard any failed layer(s) of the screen until such time that the next layer and eventually the burner itself fails and has to be replaced. Complete failure of the burner system typically occurs within a year of initial operation and can occur within months depending on factors such as how the unit is used and the frequency of the use of the unit. Removing the failed screen layers as well as the need for frequent burner replacement can result in significant down time for conveyor broilers. Moreover, as a restaurant may commonly only have only one conveyor broiler, such down time can result in significant loss of sales.

Thus, there is a need and a demand for improved conveyor charbroilers and associated assemblies such as, for example, exhibiting improved conveyor charbroiler durability and/or heat distribution.

### SUMMARY OF THE INVENTION

The invention generally relates to a burner assembly for a charbroiler. The general object of the invention can be attained, at least in part, through a burner assembly. The burner assembly includes a burner box with an inlet for the introduction of a combustible mixture and a block plate integrated with the burner box. The block plate is configured to assist in a desired distribution of the combustible mixture. The burner assembly also includes a distribution plate overlying the block plate and a mesh surface above the distribution plate. The mesh surface includes only a single layer. The distribution plate is positioned between the block plate and the mesh surface.

The distribution plate includes a plurality of pores to permit desired distribution of the combustible mixture through the plurality of pores. The pores are sized small enough to avoid or prevent flashback. The distribution plate also provides a pressure drop to the burner assembly. The distribution plate evenly distributes the combustible mixture throughout the burner assembly. The distribution plate can also create an even temperature across a surface of the burner box.

Additionally, the mesh surface of the burner assembly holds a flame to the surface of the burner box. The mesh surface consists of a single screen. The block plate of the burner assembly is positioned on a top of the burner box. The combustible mixture used in the burner assembly preferably includes a fuel gas and an oxidant.

The invention also includes an improvement to a burner assembly including a burner box with an inlet for the introduction of a combustible mixture. The burner box includes a block plate to assist in desired distribution of the combustible mixture. The improvement includes a pressure distribution plate overlying the block plate and a mesh layer overlying the pressure distribution plate. The mesh layer holds a flame to a surface of the burner box.

The pressure distribution plate includes a plurality of pores to permit desired distribution of the combustible mixture therethrough. The pores are sized small enough to avoid or prevent flashback.

Other objects and advantages will be apparent to those skilled in the art from the following detailed description taken in conjunction with the appended claims and drawings.

### BRIEF DESCRIPTION OF THE DRAWINGS

FIG. 1 is a simplified schematic side view of a standard burner assembly;

FIG. 2 is a simplified schematic side view of the burner assembly shown in FIG. 1 but now showing screen warping such as to result in uneven pressure and flame distribution;

FIG. 3 is a simplified schematic side view of a burner assembly in accordance with one embodiment of the present invention;

FIG. 4 is simplified schematic top view of the burner assembly shown in FIG. 3;

FIG. 5 shows a pressure distribution plate in accordance with one embodiment of the invention;

FIG. 6 illustrates operation with an existing burner design: and

FIG. 7 illustrates operation with a burner designed in accordance with one embodiment of the invention.

Unless otherwise specifically noted, articles depicted in the drawings are not necessarily drawn to scale.

### DETAILED DESCRIPTION

The present invention contemplates new and improved conveyor cooking appliances and assemblies such as charbroilers that utilize box burners with, having or containing a high temperature metal screen or mesh surface to provide even heat and consistent cooking results as well as a more reliable longer lasting burner. The design incorporates a block plate to distribute a fuel gas and air mixture as well as a distribution plate under the metal mesh surface. The distribution plate and the mesh surface provide a needed pressure drop for the cooking appliances. The distribution plate and the mesh surface can also evenly distribute the fuel gas and air mixture How and create a very even surface flame temperature across the whole surface of the burner without having to use multiple layers of screens.

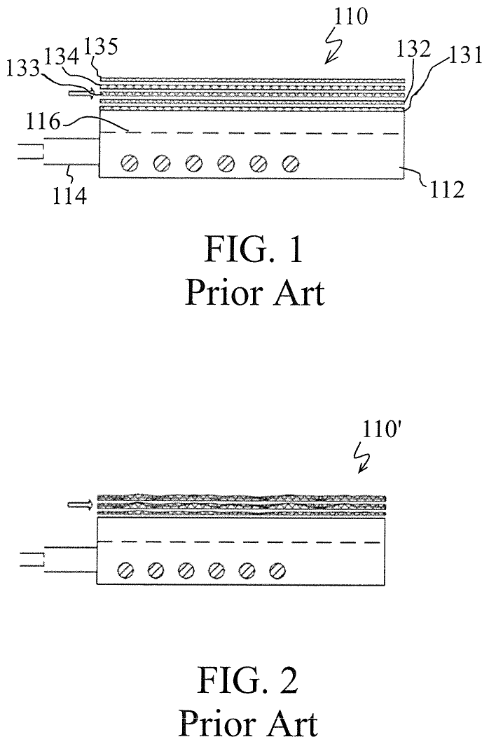

As described above, FIGS. 1 and 2 show schematics of standard burner assemblies in the prior art. The present invention is intended to remedy deficiencies in these prior art assemblies.

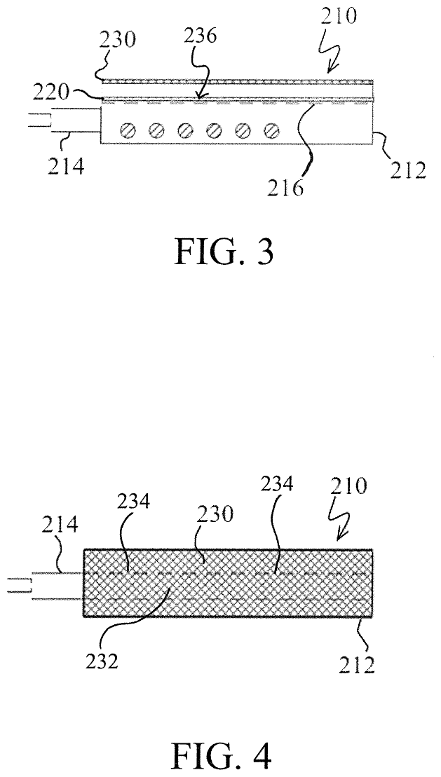

FIG. 3 shows a burner assembly 210. The burner assembly 210 includes a box burner 212 with an inlet 214 for the introduction of a fuel gas (e.g., natural gas) and oxidant (e.g., air) combustible mixture. The box burner also includes a block plate 216 to assist in desired distribution of the combustible mixture. A pressure distribution plate 220 overlies the block plate 216. The pressure plate 220 underlies a screen or mesh layer 230. Preferably, the screen or mesh layer 230 is made of a single high-temperature-withstanding screen or mesh layer. Such examples of the screen or mesh layer include, but are not limited to, Iconel, Incoloy, Kanthal, and various types of steel.

With such a design, the single mesh layer 230 may preferably include a thickness of only 1/16″, as compared to the ¼″ thickness required for previous burner assemblies such as burner assembly 110 described in FIGS. 1 and 2 above. It is to be understood that other thicknesses of the single mesh layer may also be used depending on a variety of factors including material of the layer and the use and type of burner assembly. The single layer of screen 230 overlying the pressure distribution plate 220 can also serve to hold a flame to the surface of the burner assembly 210 without forming gaps in the distribution of heat. Such gaps as seen in the prior art result in uneven heating. The uneven heating causes warping and the formation of gaps in mesh screens resulting in more uneven pressure distribution and flame distribution across the assembly. Therefore, the single layer of screen 230 in the claimed invention holds the flame to the burner assembly surface without forming gaps, thus overcoming the difficulties and shortcomings associated with the uneven burning and heating of previous charbroilers.

The pressure plate 220, also sometimes termed a pressure distribution plate, desirably includes a plurality of openings or pores 236 to permit desired distribution of the combustible fuel-oxidant mixture. The plurality of pores 236 are sized to allow the combustible mixture to pass through the pores 236, while the pores 236 are also sized small enough to reduce or eliminate flashback. The combination of the pressure distribution plate 220 with the small pores 236 low inside the burner 212 can distribute the combustible mixture evenly across the burner assembly 210 and also provide a drop in pressure across the mesh layer 230. Additionally, the pressure distribution plate 220 is desirably constructed of a material durable enough to withstand operation in a combustion environment. Thus, typical suitable materials of construction may include, but are not limited to, Inconel and stainless steel, for example.

FIG. 4 shows a channel 232 downstream of the inlet 214 for the combustible mixture to travel through. The channel 232 is preferably centered inside the burner assembly 210 underneath the pressure plate 220. The channel 232 includes a plurality of holes 234 for the combustible mixture to escape through. The combustible mixture enters the burner assembly 210 from the inlet 214 and goes through the channel 232. From there, the mixture can be released from the channel 232 through the holes 234 and through the pressure distribution plate 220 before reaching the mesh layer 230, resulting in an evenly distributed burn of the mixture. In previous designs, a combustible mixture would have been released directly to a surface of the burner.

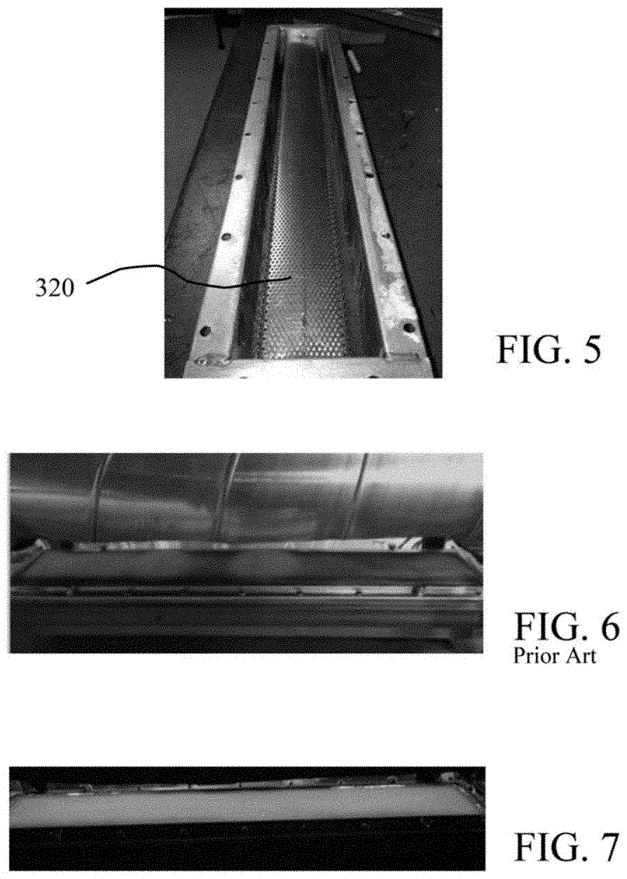

FIG. 5 shows a pressure distribution plate 320 in accordance with one embodiment of the invention. The incorporation and utilization of the pressure distribution plate provides a desired drop in pressure across the burner assembly while evenly distributing gas flow and creating an even surface flame temperature across the whole surface of the burner without having to use multiple layers of screens. FIG. 6 shows the warping that results in a burner assembly design without the even heating of the claimed invention. FIG. 7 shows improved integrity of a burner assembly incorporated with a distribution plate and single mesh layer to evenly distribute the combustible mixture within the burner box.

The subject development illustratively disclosed herein suitably may be practiced in the absence of any element, part, step, component, or ingredient which is not specifically disclosed herein.

While in the foregoing detailed description the subject development has been described in relation to certain preferred embodiments thereof, and many details have been set forth for purposes of illustration, it will be apparent to those skilled in the art that the subject development is susceptible to additional embodiments and that certain of the details described herein can be varied considerably without departing from the basic principles of the invention.

What is claimed is:

1. A burner assembly, the burner assembly comprising:
a burner box with an inlet for the introduction of a combustible mixture;
a block plate integrated with the burner box, wherein the block plate is configured to assist in a desired distribution of the combustible mixture;
a distribution plate overlying the block plate; and
a mesh surface above the distribution plate, the mesh surface comprising only a single layer.

2. The burner assembly of claim 1 wherein the distribution plate is positioned between the block plate and the mesh surface.

3. The burner assembly of claim 1 wherein the distribution plate comprises a plurality of pores to permit desired distribution of the combustible mixture therethrough.

4. The burner assembly of claim 3 wherein the plurality of pores are sized small enough to avoid or prevent flashback.

5. The humor assembly of claim 1 wherein the distribution plate is configured to provide a pressure drop to the burner assembly.

6. The burner assembly of claim 1 wherein the distribution plate is configured to evenly distribute the combustible mixture throughout the burner assembly.

7. The burner assembly of claim 1 wherein the distribution plate is configured to create an even temperature across a surface of the burner box.

8. The burner assembly of claim 1 wherein the mesh surface holds a flame to the surface of the burner box.

9. The burner assembly of claim 1 wherein the mesh surface consists of a single screen.

10. The burner assembly of claim 9 wherein the single screen comprises a metal.

11. The burner assembly of claim 10 wherein the single screen of the mesh surface comprises a thickness of 1/16 inches.

12. The burner assembly of claim 1 wherein the block plate is positioned on a top of the burner box.

13. The burner assembly of claim 1 wherein the combustible mixture comprises a fuel gas and an oxidant.

14. The burner assembly of claim 13 wherein the fuel gas is natural gas.

15. The burner assembly of claim 13 wherein the oxidant is air.

16. An improvement to a burner assembly including a burner box with an inlet for the introduction of a combustible mixture, the burner box including a block plate to assist in desired distribution of the combustible mixture, the improvement comprising:
a pressure distribution plate overlying the block plate; and
a mesh layer overlying the pressure distribution plate, the mesh layer holding a flame to a surface of the burner box.

17. The improvement to a burner assembly of claim 16 wherein the pressure distribution plate comprises a plurality of pores to permit desired distribution of the combustible mixture therethrough.

18. The improvement to a burner assembly of claim 17 wherein the pores are sized small enough to avoid or prevent flashback.

19. The improvement to a burner assembly of claim 16 wherein the mesh layer comprises a single metal screen.

20. The improvement to a burner assembly of claim 19 wherein the single metal screen comprises a thickness of preferably 1/16 inches.
